(19) United States
(12) Patent Application Publication
(10) Pub. No.: US 2026/0017800 A1
(43) Pub. Date: Jan. 15, 2026

(54) SEMANTIC SEGMENTATION AND SCENE INTEGRATION OF 3D IMAGE FRAMES

(71) Applicant: Analog Devices, Inc., Wilmington, MA (US)

(72) Inventors: Zhiwu ZHENG, Boston, MA (US); Lauren Emily MENTZER, Boston, MA (US); Michael R. PRICE, Medford, MA (US); Colm PRENDERGAST, Cambridge, MA (US); Audren Damien Prigent CLOITRE, New Haven, MA (US)

(21) Appl. No.: 19/095,449

(22) Filed: Mar. 31, 2025

Related U.S. Application Data
(60) Provisional application No. 63/671,422, filed on Jul. 15, 2024.

(51) Int. Cl. G06T 7/12; B25J 9/16; G06T 7/70; G06T 17/20; G06V 10/764

(52) U.S. Cl. CPC G06T 7/12; B25J 9/1666; G06T 7/70; G06T 17/20; G06V 10/764

(57) ABSTRACT

A computer-implemented method is provided. The aspects include deriving, by one or more processors from a pixel-wise semantic segmentation of at least two image frames, object classifications representing one or more objects in the at least two image frames. The aspects further include deriving, by the one or more processors, geometric points representing the one or more objects in the at least two image frames. The aspects also include merging, by the one or more processors, the geometric points based on the object classifications that match and a mutually closest geometric point metric to obtain merged geometric points for each of the one or more objects. The aspects additionally include controlling movement of an autonomous object to achieve a task responsive to at least one of the one or more objects represented by the merged geometric points.

### CLAIM OF PRIORITY

The present application claims priority to U.S. Provisional Application No. 63/671,422, filed on Jul. 15, 2024, which is hereby incorporated herein by reference in its entirety.

### TECHNICAL FIELD

Aspects of the present disclosure relate generally to semantic segmentation and scene integration of three-dimensional (3D) image frames.

### BACKGROUND

The lack of comprehensive scene understanding limits the capability for complex tasks in applications such as robotics.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect of the present disclosure, a computer-implemented method is provided. The method includes deriving, by one or more processors from a pixel-wise semantic segmentation of at least two image frames, object classifications representing one or more objects in the at least two image frames. The method further includes deriving, by the one or more processors, geometric points representing the one or more objects in the at least two image frames. The method also includes merging, by the one or more processors, the geometric points based on the object classifications that match and a mutually closest geometric point metric to obtain merged geometric points for each of the one or more objects. The method additionally includes controlling movement of an autonomous object to achieve a task responsive to at least one of the one or more objects represented by the merged geometric points.

In accordance with another aspect of the present disclosure, a pipeline is provided. The pipeline includes one or more processors operatively coupled to one or more memories and configured to derive, from a pixel-wise semantic segmentation of at least two image frames, object classifications representing one or more objects in the at least two image frames, derive geometric points representing the one or more objects in the at least two image frames, merge the geometric points based on the object classifications that match and a mutually closest geometric point metric to obtain merged geometric points for each of the one or more objects, and control movement of an autonomous object to achieve a task responsive to at least one of the one or more objects represented by the merged geometric points.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 is a block diagram showing a system, in accordance with an example aspect.

FIG. 2 is a block diagram showing a set of image frames to be merged, in accordance with an example aspect.

FIG. 3 is a block diagram showing a frame-to-scene fusion, in accordance with an example aspect.

FIG. 4 is a block diagram showing a pipeline, in accordance with an example aspect.

FIG. 5 is a block diagram showing a hybrid pipeline, in accordance with an example aspect.

FIG. 6 is a flowchart of an example computer-implemented method, in accordance with an example aspect.

FIGS. 7-8 are flowcharts further showing block 604 of the method of FIG. 6, in accordance with an example aspect.

FIG. 9 is a flowchart further showing blocks of the example computer-implemented method of FIG. 6, in accordance with an example aspect.

### DETAILED DESCRIPTION

Aspects of the present disclosure are directed to semantic segmentation and scene integration of three-dimensional (3D) image frames. The lack of comprehensive scene understanding limits the capability for complex tasks in applications such as robotics. The present disclosure provides for a better machine understanding of its surrounding environment. The present disclosure provides a novel pipeline that can generate a 3D semantic segmented scene by taking image frames that contain color (grayscale) and depth information (either measured or estimated). In particular, the pipeline can: (1) provide accurate segmentation with semantic labels, robust across frames; and (2) perform point cloud merging in a fast and accurate manner by leveraging the semantic information obtained in the semantic segmentation operation.

In other words, in one implementation, the disclosed system takes measured or estimated color (or grayscale) to generate segmentation masks with semantic information. Further, the disclosed system measures or estimates poses, for example, from visual odometry from Inertial Measurement Units (IMUs). Then, the proposed system performs scene integration by combining point clouds per semantic segmentation for speed and accuracy improvement. Finally, the proposed system can present the scene, for example, with Universal Scene Description (USD).

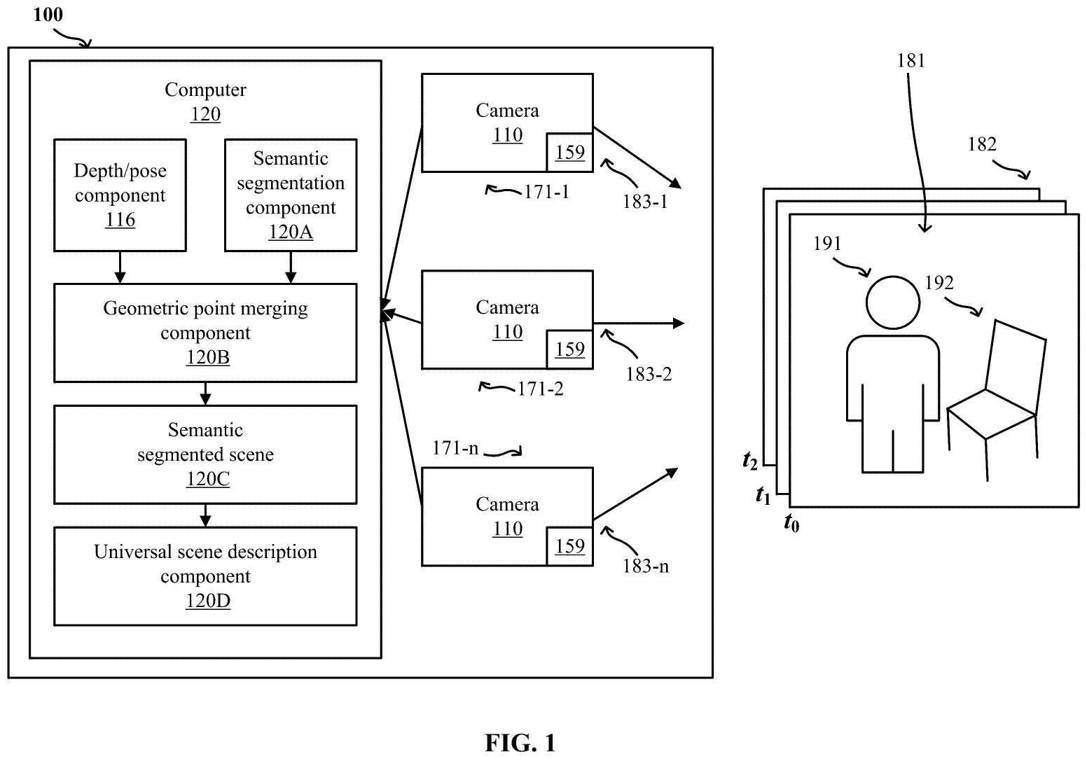

Referring to FIG. 1, a system 100 is shown, in accordance with an example aspect. In an aspect, system 100 is a computer vision system. In an aspect, system 100 is embodied in at least one of a vehicle, a robot, a game controller, a virtual reality headset, a smart device (e.g., a smart phone, smart glasses, and so forth), and so forth.

The system 100 includes a set of cameras 110. The set of cameras is configured to capture image frames 182 of a scene 181 (via, e.g., one or more Red Green Blue (RGB imagers) (e.g., at different times t₁, t₂, and t₃), provide depth information (via, e.g., one or more time of flight (TOF) imagers) for subjects (person 191, chair 192) in the scene 181, and provide positional information of the set of cameras 110 (via, e.g., on-board or connected (e.g., mounted, adhered, etc.) gyroscopes and accelerometers).

The system further includes a computer 120 having a visual odometry component 116, a semantic segmentation component 120A, a geometric point merging component 120B, and a universal scene description (USD) component 120D. Visual odometry component 116 is configured to determine camera pose with respect to the set of cameras and the scene 181 from the positional information and the depth information. Semantic segmentation component 120A is configured to perform semantic segmentation on the image frames 182. Geometric point merging component 120B is configured to perform geometric point merging on results of the semantic segmentation to generate a semantic segmented scene 120C, such as a 3 dimensional semantic segmented scene. Universal scene description (USD) component 120D is configured to convert the semantic segmented scene 120C into a USD format which is a standardized format that allows for easy data exchange between different 3D applications and platforms. USD format essentially acts as a common language for describing complex 3D scenes across various software tools. For example, the USD formatted data can be sent to one or more other systems and/or controllers for action such as in the case of operating a motor vehicle while performing object avoidance using the one or more other systems and/or controllers to perform actions such as, but not limited to, braking, steering, stability, and so forth systems.

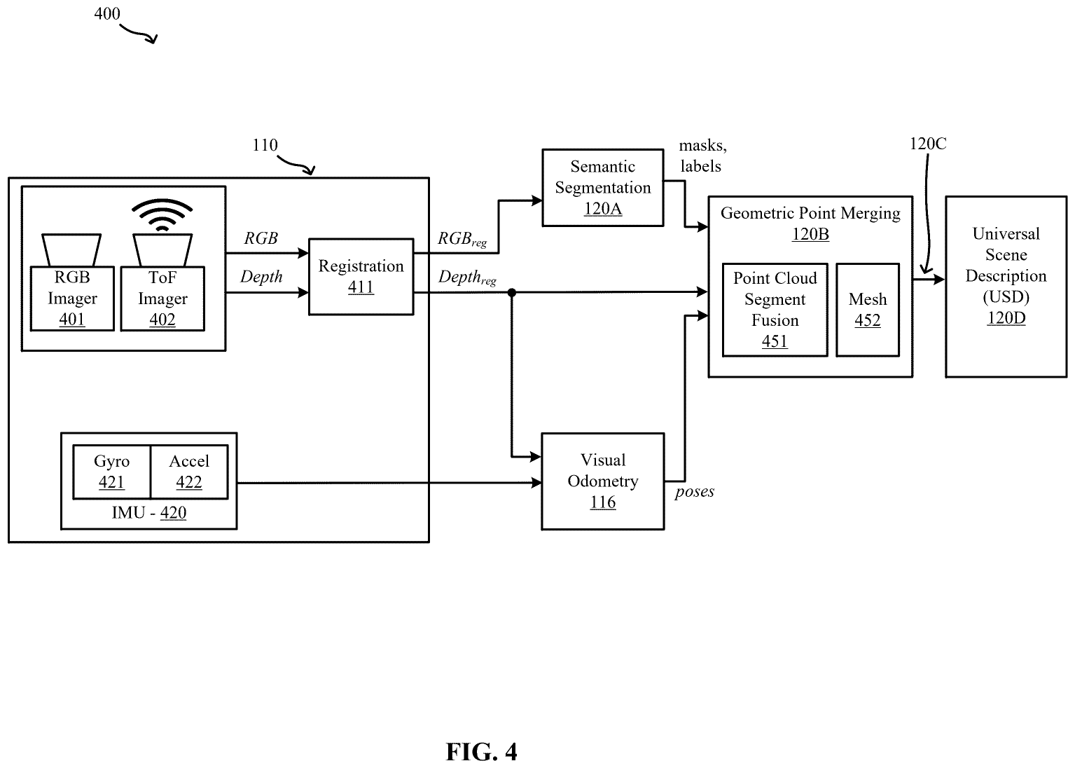

The set of cameras 110 is connected to the computer 120 using either a wired and/or a wireless connection, depending upon the implementation. One or more of the cameras in the set of cameras 110 can include IMU data generators 159 such as a gyroscope(s) (e.g., gyroscope 421 of FIG. 4) and an accelerometer(s) (e.g., accelerometer 422 of FIG. 4) for generating positional data used (by the visual odometry component 116 of FIG. 4) to determine camera pose. The set of cameras 110 can include two or more cameras for capturing different angles 183-1, 183-2, 183-n of the scene 181 or a single camera moved to two or more different locations 171-1, 171-2, 171-n to capture the different angles 183-1, 183-2, 183-n of the scene 181. Semantic segmentation is a pixel-to-pixel level segmentation performed on an image frame to output object boundaries and object labels for objects in the image frame. The pixel-to-pixel level segmentation is performed on Red Green Blue (RGB) data corresponding to an image frame. As shown in FIG. 4, the results of the semantic segmentation from the semantic segmentation component 120A may be used, along with depth information and/or camera pose information from a visual odometry component 116, to perform scene merging by the frame-to-scene fusion component 120B.

In one example, for instance, the cameras 110 can be still and/or video cameras configured to capture multiple image frames 182 such as one showing a person 191 and a chair 192. While a person 191 and chair 192 are shown with respect to image capture, other objects may be captured in other cases. For example, system 100 may be implemented in a vehicle, in which case, other vehicles, pedestrians, and objects may be captured for purposes of vehicle control and/or object avoidance. In another example, system 100 may be implemented in a robot, such that different locations from and to which items are to be removed and replaced may be captured for purposes of robot control and/or object movement/flow such as, e.g., in an assembly line. The preceding examples are merely illustrative.

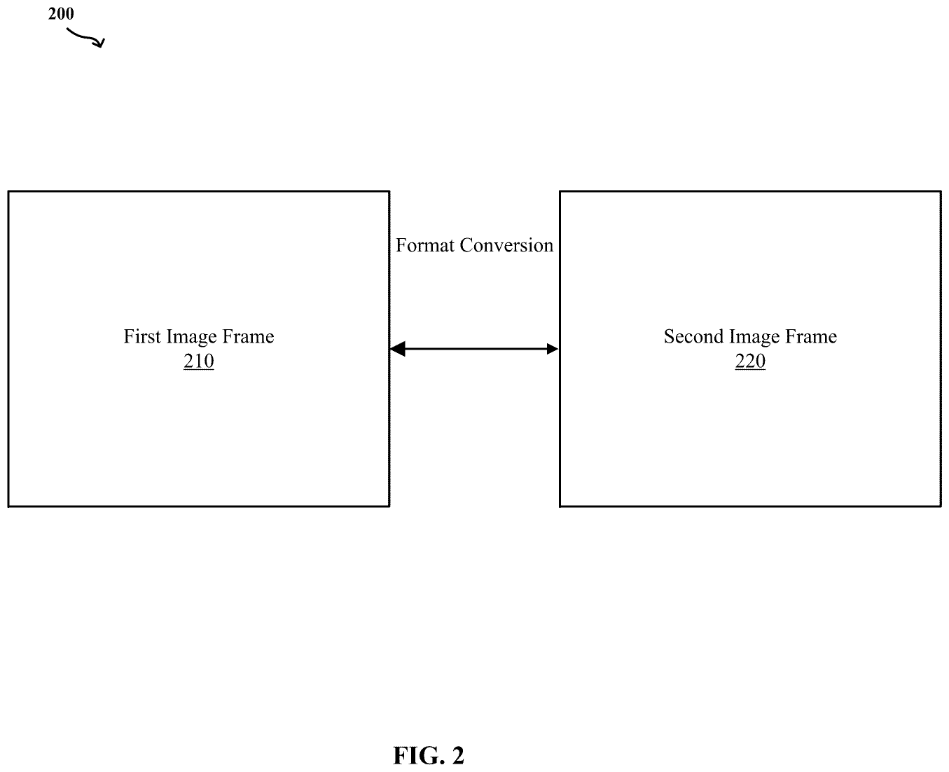

Referring to FIG. 2, a set of image frames 200 to be merged is shown, in accordance with an example aspect. The set of image frames 200 may be one example of a frame conversion performed to enable the set of image frames 200 to be merged. In an aspect, a prerequisite to merging is converting all the frames to be merged to (i) have common depth information (that is, relate to a common depth from among the different depths resulting from the different locations 171-1, 171-2, 171-n and/or different angles 183-1, 183-2, 183-n) and (ii) use the same coordinate system.

The set of image frames 200 includes a first image frame 210, also known as a reference frame, and a second image frame 220 whose coordinate system and camera pose are converted to the coordinate system and camera pose of the first image frame 210 using the different locations 171-1, 171-2, 171-n and/or different angles 183-1, 183-2, 183-n in a format conversion to enable determining correspondence based on an amount of overlap. In an aspect, the amount of overlap is a user settable threshold. While image frame 220 is shown being converted to the coordinate system and camera pose of image frame 210, the reverse is also possible, that is, converting the coordinate system and camera pose of image frame 210 into the coordinate system and camera pose of image frame 220. The conversion of coordinate system geometric points from one camera frame to another is only relevant to the point cloud fusion portion and is not relevant to the semantic segmentation portion. It is to be appreciated that the fusion of point clouds based on label classes can be made from label classes acquired from any semantic segmentation method that takes images as input and outputs labels for objects depicted in the images, and not only from the semantic segmentation method described herein.

Geometric points can include, for example, but are not limited to three-dimensional (3D) geometric points (horizontal (x), vertical (y), and depth (z)), and so forth.

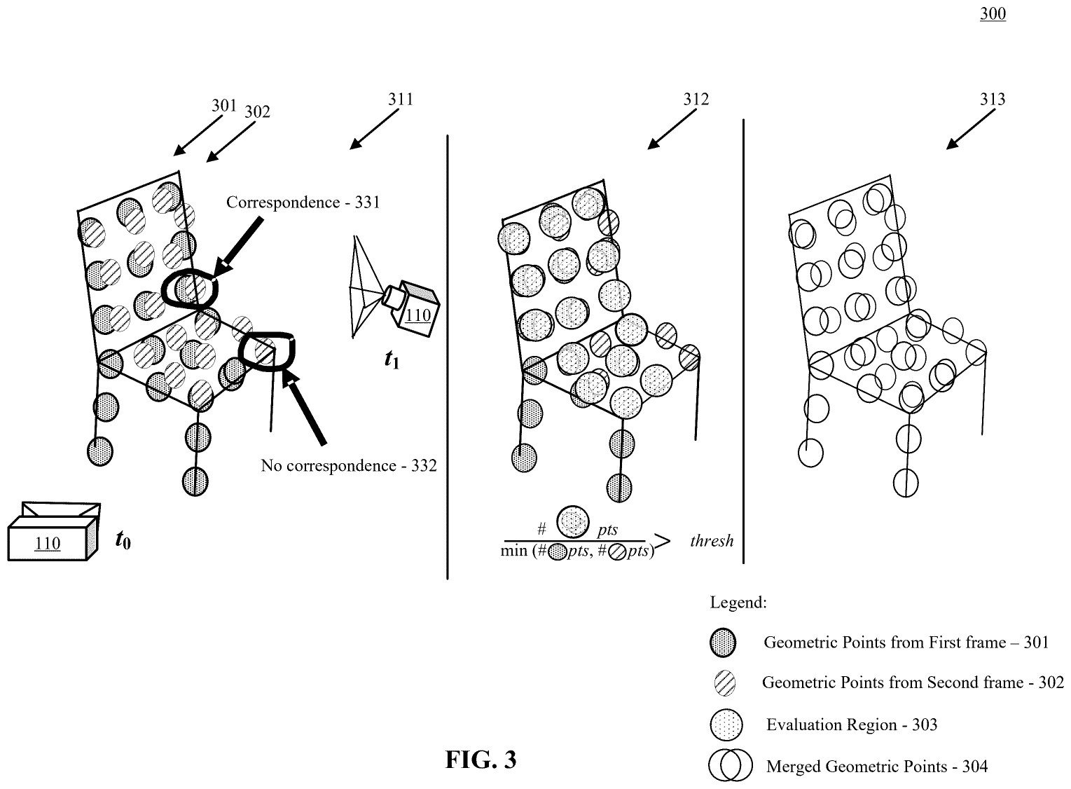

Referring to FIG. 3, a frame-to-scene fusion 300 is shown, in accordance with an example aspect.

The frame-to-scene fusion 300 performed by the geometric point merging component 120B involves point cloud data 301 (also referred to as “geometric points from first frame 210”) and point cloud data 302 (also referred to as “geometric points from second frame 220”) for at least two image frames (e.g., point cloud data 301 is derived from first image frame 210 (e.g., corresponding to time t₀) and point cloud data 302 is derived from second image frame 220 (e.g., corresponding to time t₁)). FIG. 3 shows a legend for point cloud data 301, point cloud data 302, an evaluation region 303 between point cloud data 301 and point cloud data 302, and a merged frame region (also referred to as “merged geometric points”) 304 for portions of point cloud data 301 and point cloud data 302 that overlap.

The point cloud data 301 and the point cloud data 302 are evaluated for overlap to determine correspondence. In an aspect, correspondence is determined when there is at least 30-40% or some other predetermined minimum amount or predetermined minimum range of overlap between two point clouds as indicated by a mutually closest geometric point metric. The mutually closest geometric point metric is a metric that indicates geometric overlap between points in at least two compared point clouds. In an aspect, the at least two point clouds include point cloud data for the same class of objects. For example, the at least two point clouds pertain to a chair or a floor or a wall or some other common object between the at least two images that the at least two point clouds essentially represent.

In a first stage 311, correspondences (overlap) 331 are found between the point cloud data 301 and the point cloud data 302 for the same class of objects in the at least two image frames. For instance, to determine whether two points in point cloud data 301, 302 (here, corresponding to two image frames, but capable of corresponding to more than two images frames) have correspondence 331, it is determined whether those points are common between, that is, included in, the point cloud data of the at least two image frames. If so, each of the common points contribute to the overlap. Otherwise, no correspondence 332, that is, no overlap, is found.

In a second stage 312, the overlaps are evaluated, e.g., against a threshold amount or range to determine a degree of correspondence. Such evaluation is performed with respect to an evaluation region 303 in which overlap is determined between the at least two image frames 210 and 220. For instance, once the overlap is found per first stage 311, the overlap, which may be represented numerically as described herein, is compared to a threshold value thresh to determine whether the point cloud data of the two frames have correspondence 331 above a threshold amount. For example, in one exemplary aspect, correspondences (overlap) between the points are found by looking at a point in a frame and finding a mutually closest point in the other frame and then dividing the number of points in the point cloud data 301 of one point cloud by the total number of points in the point cloud data 302 of the other point cloud. In an aspect, a first one of two point clouds is represented by point cloud data 301 and a second one of two point clouds is represented by point cloud data 302, and the number of overlapping (common) points between the two point clouds is divided by the number of points in the smaller point cloud (which includes less points than the larger point cloud) from among the two point clouds to compute the metric.

In a third stage 313, the point cloud data 301, 302 of the two frames that have correspondence 331 above a threshold amount, that is, that have a mutually closest geometric point metric above a threshold amount, are merged. For instance, the metric computed as described with respect to second stage 312 is compared to a threshold value and if the metric is greater than the threshold value, then the frames 210, 220 involved in computation of the metric are merged; otherwise, the frames are not merged.

Referring to FIG. 4, a pipeline 400 is shown, in accordance with an example aspect. The pipeline 400 is one example of at least a portion of the system 100 of FIG. 1 for performing semantic segmentation on the image frames and geometric point merging on results of the semantic segmentation in order to generate a semantic segmented scene.

A Red Green Blue (RGB) or other type of imager 401 (BGR, monochromatic, etc.) and a Time of Flight (ToF) imager 402 are configured to provide RGB data RGB_{REG} and depth data Depth_{REG}, respectively, to a registration component 411, e.g., in at least one of the imagers 401 and 402, that registers (aligns and/or otherwise associates, e.g., based on timestamp) the RGB data with the depth data. The color and depth information can be obtained from real data and/or may be inferred. Any type of color image or monochromatic imager may be used, depending upon the implementation. In an aspect, imager 401 and imager 402 are implemented by one or more of cameras 110 in FIG. 1. For example, in an aspect, both types of imagers 401 and 402 are included each of the cameras 110. In another aspect, separate devices are used for the two types of imagers 401 and 402.

Inertial measurement unit (IMU) data generator 159, having a gyroscope (gyro) 421 and an accelerometer (accel) 422, is configured to provide positional data. From the positional data, the visual odometry component 116 of computer 120 is configured to calculate camera pose. The IMU output is relative to the camera pose. In an aspect, IMU 420 is implemented by one or more of the cameras in the set of cameras 110 of FIG. 1. For example, in an aspect, each camera may be mounted on a common mounting platform on which are mounted one or more gyroscopes 421 and one or more accelerometers 422. In another aspect, each camera may be independently mounted with its own gyroscope(s) and accelerometer(s) for generating IMU data including positional data.

A visual odometry component 116 is configured to provide camera pose data responsive to the positional data from the IMU 420 and the depth data from the registration component 411.

The semantic segmentation component 120A is configured to provide masks (segmentations) and labels for the segmentations from a closed set of segmentation and labels, responsive to RGB data from the registration component 411.

The geometric point merging component 120B is configured to perform point cloud segment fusion 451 to provide segmented meshes 452, responsive to the segmentations and labels from the semantic segmentation component 120A, the depth data from the registration component 411, and the camera pose data from the visual odometry component 116. Point cloud segment fusion leverages segmentation per semantic class by evaluating overlap between the same semantic mask of image frames.

Regarding the frame-to-scene fusion component 120B, the following may be implemented in an example aspect.

Objective: Fuse segmented point clouds from frame 2 into frame 1

Given:
msegmented+labeled point clouds in frame 1
nsegmented+labeled point clouds in frame 2

Output:
psegmented+labeled+fused point clouds

A mesh component 452 is configured to fuse segmented meshes into scene meshes.

A universal scene description (USD) component 120D is configured to convert the scene meshes into a USD format.

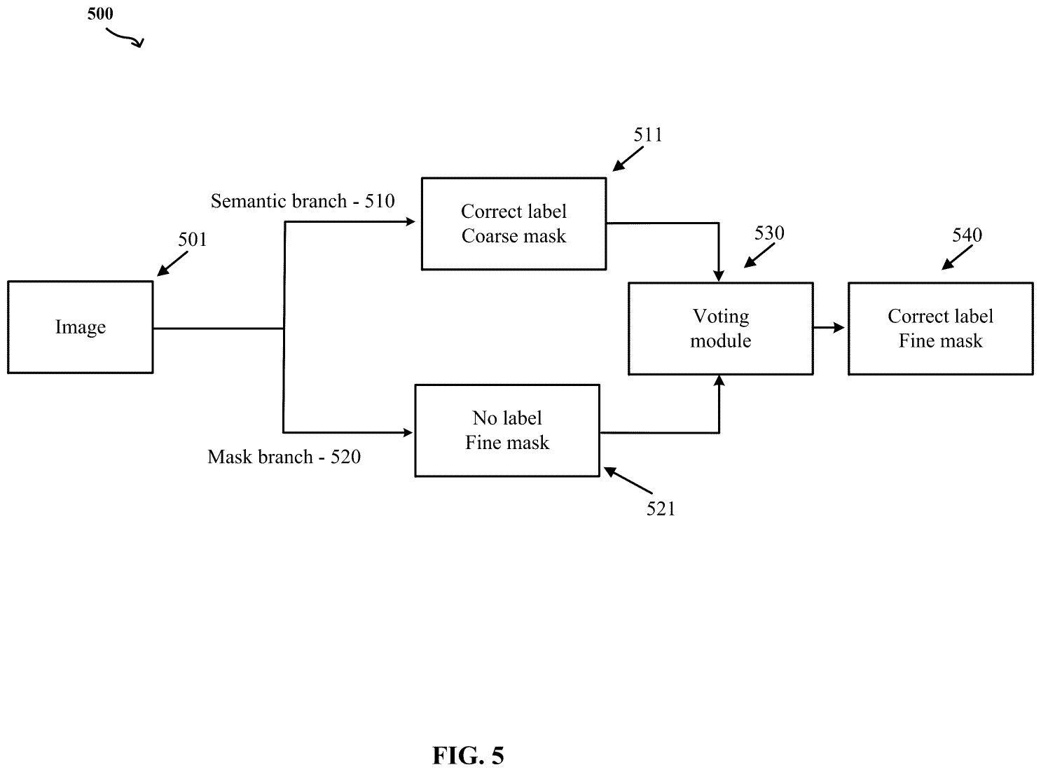

Referring to FIG. 5, a hybrid pipeline 500 is shown, in accordance with an example aspect. It is hybrid in using the semantic segmentation of FIG. 4 along with the Segment Anything Model (SAM). In an aspect, the hybrid pipeline 500 implements the semantic segmentation component 120A of FIG. 1 and FIG. 4. It is to be appreciated that while SAM is mentioned, other mask-based object segmentation models and/or methods for segmenting an object from an image using a mask may be used in a hybrid approach along with the semantic segmentation of FIG. 4.

Image data 501, corresponding to image frames 182 of FIG. 1 and/or RGB data RGB_{REG} and depth data Depth_{REG} of FIG. 4, is processed in two branches, namely a semantic branch 510 and a mask branch (e.g., SAM branch or other mask-based object segmentation model and/or method for segmenting an object from an image using a mask) 520 to provide respective semantic segmentation results 511 (segmentations and class labels for the segmentations) and (fine-grained (e.g., fine-edged)) “mask results with no label 521”. The mask results with no label 521 include a mask for an image with object occupied areas of the mask indicated differently than non-object-occupied areas of the mask. The network architecture of the SAM includes an encoder and a decoder. The encoder takes in the image and user prompt inputs to produce image embedding, image positional embedding and user prompt embeddings. The decoder takes in the various embeddings to produce segmentation masks and confidence scores. SAM and other mask-based object segmentation models and/or methods may thus provide more fine-grained (e.g., fine-edged) segmentation results also referred to as “mask results with no label 521” which are segmentation masks and may also include confidence scores, as compared to coarse-grained object edges resulting from the mask branch 520.

Semantic segmentation is described herein above. To reiterate, it is a process of generating segmentations and class labels for the segmentations from a closed set of segmentations and corresponding class labels, responsive to RGB data. The class labels resulting from semantic segmentation very accurately identify the proper class for a given segmentation. However, the object edges are coarse compared to the mask results approach by the mask branch 520.

Regarding the mask results and the mask branch 520, the technique obtains finely detailed masks, but without class labels. Such method could be the Segment Anything Model (SAM) published by Meta, but aspects of the present disclosure are not limited to this method. The method takes the color image as an input and outputs a high-quality mask for every different object. The mask branch 520 could also output hierarchical masks (e.g., it can output a mask of a human and another mask of the left arm of the person). The image mask resulting from the mask branch 520 is finer than the segmentations resulting from the semantic segmentation. However, the image mask is without class categorization.

The results of the two branches 510 and 520 are voted on by a semantic voting module 530 to output fine segmentations and correct class labels 540 for the fine segmentations. The semantic voting module 530 collects the pixel-wise class labels generated by the branch 510 for all pixels of the image under consideration. For each mask produced by the branch 520, the semantic voting module 530 determines the class label for this mask using a simple majority vote. In other implementations, the semantic module 530 can compute the proportion of pixels belonging to each class label appearing in the mask relative to the total number of pixels in that mask. If the highest proportion computed is above a set threshold, then the semantic voting module 530 considers this mask to be of the type of that class label. Regardless of the voting method, in an aspect, the semantic voting module 530 sets all pixels in that mask or at least a minimum predetermined number of pixels in that mask to be of the type of that class label.

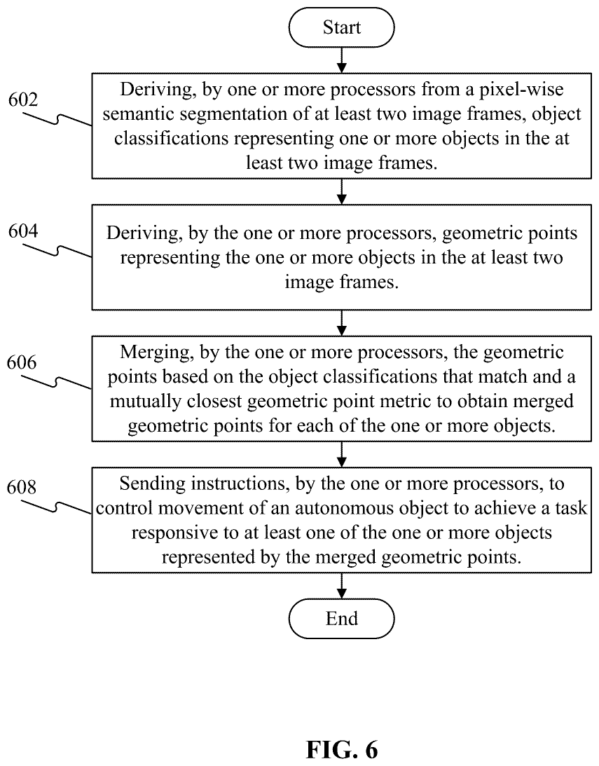

FIG. 6 is a flowchart of an example computer-implemented method 600 for performing semantic segmentation on the image frames and geometric point merging on results of the semantic segmentation in order to generate a semantic segmented scene, in accordance with an example aspect. In an aspect, all real-world geometries are captured and represented as geometric points by method 600. Two images 210, 220 are obtained, where each pixel in one image 210 include color information and each pixel in the other image 220 includes depth information. The color image is processed to obtain semantic information, and the depth information is processed to obtain geometric points. Method 600 then combines all this information into one coherent, semantic, and 3D representation.

At block 602, the method 600 includes deriving, by one or more processors from a pixel-wise semantic segmentation of at least two image frames, object classifications (e.g., labels) representing one or more objects in the at least two image frames. The semantic segmentation component 120A of the one or more processors derives the object classifications from the pixel-wise semantic segmentation of the at least two image frames.

At block 604, the method 600 includes deriving, by the one or more processors, geometric points representing the one or more objects in the at least two image frames. The semantic segmentation component 120A of the one or more processors derives the geometric points from the pixel-wise semantic segmentation of the at least two image frames.

At block 606, the method 600 includes merging, by the one or more processors, the geometric points based on the object classifications that match and a mutually closest geometric point metric to obtain merged geometric points for each of the one or more objects. The point cloud segment fusion 451 performed by the one or more processors merges the geometric points based on the object classifications that match and the mutually closest geometric point metric to obtain the merged geometric points for each of the one or more objects.

In an aspect, the merging of geometric points involves the merging of the respective point cloud data of each of the at least two image frames by the geometric point merging component 120B of the one or more processors. The geometric point merging component 120B is configured to perform point cloud segment fusion 451 to provide segmented meshes 452, responsive to the segmentations and labels from the semantic segmentation component 120A, the depth data from the registration component 411, and the camera pose data from the visual odometry component 116.

In an aspect, the mutually closest geometric point metric is calculated using geometric overlap. In an aspect, the point cloud segment fusion 451 determines which collections of points in one frame correspond to the same object as another collection of points in the other frame. In an aspect, the point cloud segment fusion finds point cloud correspondences between two frames. In an aspect, camera poses are used to place all points into a same frame since the data from the two frames that are combined overlaps to a degree which is determined by the mutually closest geometric point metric. There may be more or less information for a particular object in one frame or the other, and thus it is determined which collections of points are actually of the same object. Hence, if there exists points for a chair in one frame and a chair in the other frame, it is determined if those points correspond to the same chain by looking at geometric overlap of the respective point clouds corresponding to the object. In an aspect, overlap is established by computing the mutually closest geometric point metric. To that end, correspondences between the points are found by looking at a point in a frame and finding a mutually closest point in the other frame. A correspondence is formed if the distance between two mutually closest points is within a tunable value called the evaluation region. Geometric points that are mutually closest but whose distance is bigger than set by the evaluation region are not considered to form a correspondence. The two sets of points are merged into one set if the ratio between the number of correspondences and the minimum between the number of points in the first frame and the number of points in the second frame is larger than a tunable threshold.

Hence, if there is a high degree of overlap, then that ratio should be close to 1. Conversely, if there is a low degree of overlap, that ratio should be close to 0. The mutually closest geometric point metric is only computed for objects of the same classes, and overlap is not evaluated between, e.g., a chair versus a floor or a chair versus a wall.

At block 608, the method 600 includes sending, by the one or more processors, instructions to control movement of an autonomous object to achieve a task responsive to at least one of the one or more objects represented by the merged geometric points. In an aspect, the task includes avoiding an obstacle. In an aspect, avoiding an obstacle includes increasing or decreasing the forward momentum, imparting a rotational force, imparting a stabilizing force(s), applying braking and/or steering, and so forth. In an aspect, the task includes moving an object from a first location to a second location. In an aspect, the task is performed on an assembly line by a robot that moves a fender and/or other vehicle component from one station of the assembly line to another station of the assembly line.

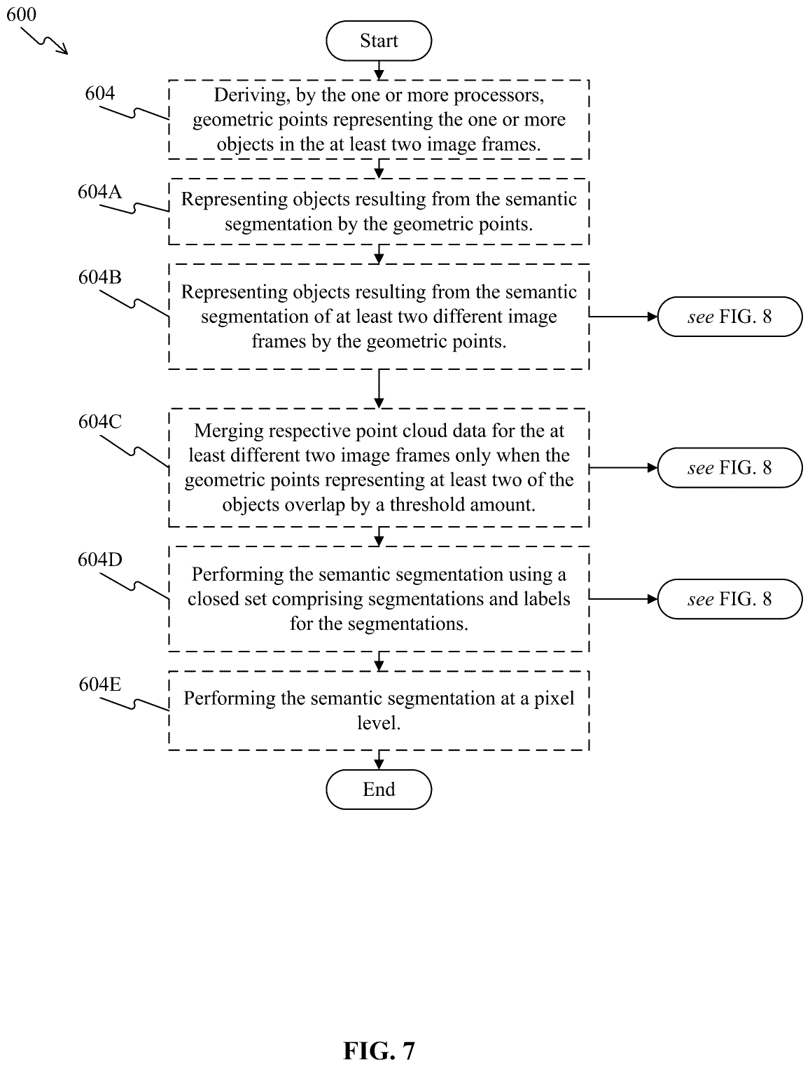

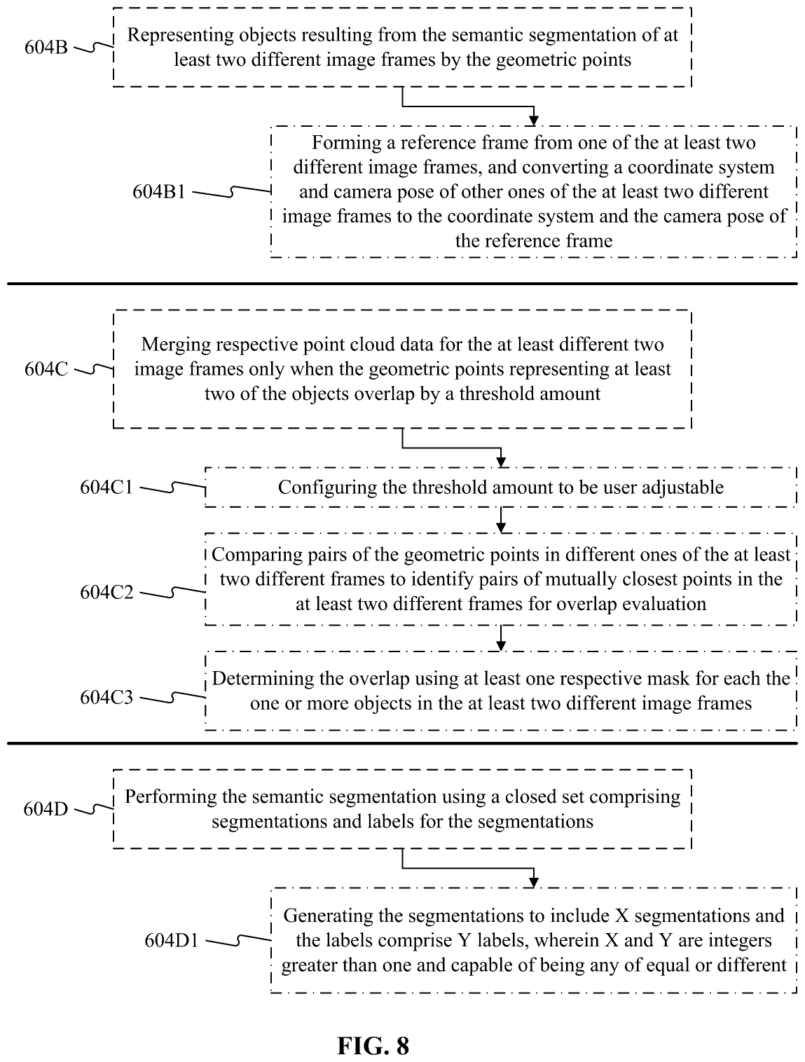

FIGS. 7-8 are flowcharts further showing blocks relating to block 604 of the computer-implemented method 600 of FIG. 6, in accordance with an example aspect. The blocks shown and described in relation to FIG. 6 relate to a semantic segmentation as described herein.

In an aspect, block 604 may include one or more of blocks 604A through 604E.

At block 604A, the method 600 includes representing objects resulting from the semantic segmentation by the geometric points. The semantic segmentation component 120A represents the objects resulting from the semantic segmentation by the geometric points.

At block 604B, the method 600 includes representing objects resulting from the semantic segmentation of at least two different image frames by the geometric points. The semantic segmentation component 120A represents the objects resulting from the semantic segmentation of at least two different image frames by the geometric points. For example, for a given shape and/or potential object, a number of predetermined points or certain available points or all found points within the shape or periphery of the object are identified and/or used. In an aspect, the points may correspond to and/or otherwise be mapped to positions in a mask. In an aspect, down-sampling may be used to reduce the data (the number of geometric points) for, e.g., purposes of computational speed, memory consumption reduction, bandwidth reduction, and so forth due to the involvement of less geometric points. In an aspect, up-sampling may be used to increase the data (the number of geometric points) for, e.g., purposes of increased accuracy due to the involvement of more geometric points. In an aspect, up-sampling may be used to fill in values in a mask(s) than would otherwise be unfilled. Moreover, up-sampling and/or down-sampling may be used to match the positions in a mask(s).

In an aspect, block 604B may include block 604B1.

At block 604B1, the method 600 includes forming a reference frame from one of the at least two different image frames, and converting a coordinate system and camera pose of other ones of the at least two different image frames to the coordinate system and the camera pose of the reference frame. The geometric point merging component 120B forms the reference frame and performs the coordinate system and camera pose conversion from those of the non-reference frame to those of the reference frame. This block of coordinate system and camera pose conversion pre-processes the at least two different image frames to match the coordinate system and camera pose of a reference frame to provide data uniformity in preparation for data merging.

At block 604, the method 600 includes merging respective point cloud data for the at least different two image frames only when the geometric points representing at least two of the objects overlap by a threshold amount. The point cloud segment fusion 451 merges the respective point cloud data for the at least two different images. This threshold may be automatically adjusted using artificial intelligence and/or empircal data. For example, empirical data may be used to arrive at an initial threshold that is then refined over time by artificial intelligence.

In an aspect, block 604C may include one or more of blocks 604C1 through 604C3.

At block 604C1, the method 600 includes configuring the threshold amount to be user adjustable. This block may involve providing a range of values as thresholds from which a user selects an applicable threshold.

At block 604C2, the method 600 includes comparing pairs of the geometric points in different ones of the at least two different frames to identify pairs of mutually closest points in the at least two different frames for overlap evaluation. The point cloud segment fusion 451 compares the pairs of the geometric points from pairs of point clouds corresponding to two different frames from among the at least two different frames. In an aspect, the point clouds are object-level point clouds that each represent an object in a particular frame from among at least two different frames. Thus, with respect to two overlapping point clouds, for a currently evaluated point in a given point cloud in one point cloud, the closest point in the other point cloud is found. The mutually closest geometric point metric is then computed with respect to the these two points, i.e., the currently evaluated point in the given point cloud (corresponding to a given image) and the point in the other point cloud (corresponding to a different image, e.g., the next or preceding or subsequent frame in a frame sequence) that is closest to the currently evaluted point.

At block 604C3, the method 600 includes determining the overlap using at least one respective mask for each of the one or more objects in the at least two different images frames. Mask values may be compared for overlap by finding common values in common positions between two or more masks.

At block 604D, the method 600 includes performing the semantic segmentation using a closed set comprising segmentations and labels for the segmentations.

In an aspect, block 604D may include block 604D1.

At block 604D1, the method 600 includes generating the segmentations to include X segmentations and the labels comprise Y labels, wherein X and Y are integers greater than one and capable of being any of equal or different to each other.

At block 604E, the method 600 includes performing the semantic segmentation at a pixel level.

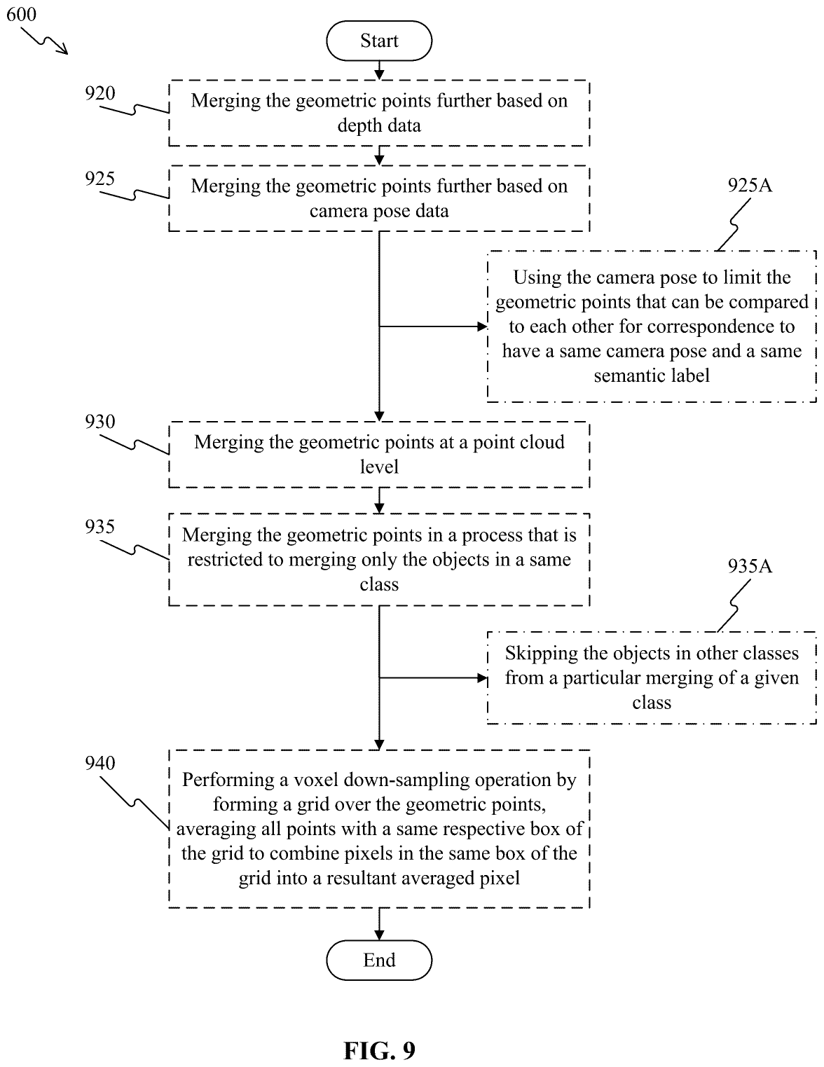

FIG. 9 is a flowchart further showing blocks of the example computer-implemented method 600 of FIG. 6, in accordance with an example aspect.

At block 920, the method 600 includes merging the geometric points further based on depth data. The geometric point merging component 120B merges the geometric points. The depth data is used to determine a distance from a surface of an object to a viewing point. In an aspect, the geometric points may be merged based on having common depth data for a given viewpoint (objects in two frames are at the same distance in each frame from the viewing point) or scaled depth data that represents the increasing and decreasing size of the image due to depth (the object is smaller because the object is further away from the viewing point in a scene or larger because the object is closer to the viewing point in the scene). In an aspect, the use of depth data makes the object representations by points in the point cloud to be more representative of the actual object. In an aspect, the depth data can be normalized across different images from the same or different cameras to account for any differences in depth. In an aspect, in addition to accounting for differences in depth, differences in the depth data due to objects being in different locations can be accounted for with respect to a viewpoint, e.g., a common viewpoint. In an aspect, scaling of the data such as size data of the object may be used to make an object appear larger when the object is closer and make the object appear smaller when the object is farther away. Other ways to normalize depth data can be used.

At block 925, the method 600 includes merging the geometric points further based on camera pose data. The geometric point merging component 120B merges the geometric points. The camera pose data is used to determine the position and orientation of the camera. In an aspect, the geometric points may be merged based on having common depth data. In an aspect, depth data between two cameras having different camera poses and hence different camera pose data can be formatted to match one or the other of camera poses or a third camera pose corresponding to a target or normalizing camera pose. In an aspect, the use of camera pose makes the object representations by points in the point cloud to be more representative of the actual object. In an aspect, the camera position and orientation can be normalized across different images from the same or different cameras to account for any differences in their poses and/or orientations.

In an aspect, block 925 may include block 925A.

At block 925A, the method 600 includes using the camera pose to limit the geometric points that can be compared to each other for correspondence to have a same camera pose and a same semantic label. The same camera pose refers to the same camera position and orientation. The same semantic label refers to the same class label, such as tree, chair, car, person, and so forth.

At block 930, the method 600 includes merging the geometric points at a point cloud level. In an aspect, merging the geometric points at a point cloud level involves a pair-wise point comparison of a point from one point cloud and a point in another point cloud to determine if those two points are the closest when the point from the one point cloud is compared to other points in the other point cloud.

At block 935, the method 600 includes merging the geometric points in a process that is restricted to merging only the objects in a same class (objects that have the same semantic or class label).

In an aspect, block 935 may include block 935A.

At block 935A, the method 600 includes skipping the objects in other classes from a particular merging of a given class.

At block 940, the method 600 includes performing a voxel down-sampling operation by forming a grid over the geometric points, averaging all points with a same respective box of the grid to combine pixels in the same box of the grid into a resultant averaged pixel.

Additional aspects of the present disclosure may be implemented according to one or more of the following clauses.

Clause 1. A computer-implemented method, comprising: deriving, by one or more processors from a pixel-wise semantic segmentation of at least two different image frames, object classifications representing one or more objects in the at least two different image frames; deriving, by the one or more processors, geometric points representing the one or more objects in the at least two different image frames; merging, by the one or more processors, the geometric points based on the object classifications that match and a mutually closest geometric point metric to obtain merged geometric points for each of the one or more objects; and sending instructions to control a movement of an autonomous object to achieve a task responsive to at least one of the one or more objects represented by the merged geometric points.

Clause 2. The computer-implemented method in accordance with clause 1, wherein the geometric points are merged in a process that is restricted to merging only objects in a same class.

Clause 3. The computer-implemented method in accordance with any preceding clauses, wherein restricted to merging only objects in the same class skips any of the one or more objects that are in other classes from a particular merging of a given class.

Clause 4. The computer-implemented method in accordance with any preceding clauses, wherein the geometric points are merged at a point cloud level.

Clause 5. The computer-implemented method in accordance with any preceding clauses, wherein point cloud data for the at least one of the one or more objects in the at least different two image frames are mergeable only when the point cloud data for the at least one of the one or more objects in the at least different two image frames include an overlap by a threshold amount with respect to the mutually closest geometric point metric.

Clause 6. The computer-implemented method in accordance with any preceding clauses, wherein the threshold amount is user adjustable.

Clause 7. The computer-implemented method in accordance with any preceding clauses, further comprising determining the overlap using at least one respective mask for each the one or more objects in the at least two different image frames.

Clause 8. The computer-implemented method in accordance with any preceding clauses, further comprising comparing pairs of the geometric points in different ones of the at least two different frames to identify pairs of mutually closest points in the at least two different frames for overlap evaluation.

Clause 9. The computer-implemented method in accordance with any preceding clauses, further comprising performing the semantic segmentation using a closed set comprising segmentations and labels for the segmentations.

Clause 10. The computer-implemented method in accordance with any preceding clauses, wherein the segmentations comprise X segmentations and the labels comprise Y labels, and wherein X and Y are integers greater than one and capable of being any of equal or different.

Clause 11. The computer-implemented method in accordance with any preceding clauses, wherein the geometric points are merged further based on depth data.

Clause 12. The computer-implemented method in accordance with any preceding clauses, wherein the geometric points are merged further based on camera pose data.

Clause 13. The computer-implemented method in accordance with any preceding clauses, further comprising using the camera pose data to limit the geometric points that can be compared to each other for correspondence to have a same semantic label and to belong in a field-of-view of all camera poses under consideration.

Clause 14. The computer-implemented method in accordance with any preceding clauses, wherein the geometric points are represented by image meshes and merged into scene meshes.

Clause 15. The computer-implemented method in accordance with any preceding clauses, further comprising performing a voxel down-sampling operation by forming a grid over the geometric points, averaging all points with a same respective box of the grid to combine pixels in the same box of the grid into a resultant averaged pixel.

Clause 16. The computer-implemented method in accordance with any preceding clauses, wherein controlling movement of the autonomous object comprises controlling movement of a robot to achieve the task responsive to the merged geometric points.

Clause 17. The computer-implemented method in accordance with any preceding clauses, wherein the task comprises avoiding an obstacle.

Clause 18. The computer-implemented method in accordance with any preceding clauses, wherein the task comprises moving an object from a first location to a second location.

Clause 19. A pipeline, comprising: one or more processors operatively coupled to one or more memories and configured to derive, from a pixel-wise semantic segmentation of at least two different image frames, object classifications representing one or more objects in the at least two different image frames, derive geometric points representing the one or more objects in the at least two different image frames, merge the geometric points based on the object classifications that match and a mutually closest geometric point metric to obtain merged geometric points for each of the one or more objects, and send instructions to control a movement of an autonomous object to achieve a task responsive to at least one of the one or more objects represented by the merged geometric points.

Clause 20. The pipeline in accordance with clause 19, wherein the one or more processors are further configured to implement a semantic segmentation branch and perform semantic segmentation on an image frame to output segmentations of the image frame and class labels for the segmentations from a closed set of segmentations and class labels, responsive to red, green, blue (RGB) image data.

Clause 21. The pipeline in accordance with any preceding clauses, wherein the one or more processors are further configured to implement a mask branch configured to perform mask-based segmentation to output mask-based segmentations without class labels.

Clause 22. The pipeline in accordance with any preceding clauses, wherein the one or more processors are further configured to perform semantic voting to output final segmentations with a finer granularity than the mask-based segmentation with final class labels, responsive to inputs comprising the segmentations and the labels for the segmentations output from the semantic segmentation and the mask-based segmentations output from the mask-based segmentation.

Clause 23. The pipeline in accordance with any preceding clauses, wherein the one or more processors are further configured to generate 3D scenes from perception that comprises color and depth information.

Clause 24. The pipeline in accordance with any preceding clauses, wherein one or more processors are further configured to perform, along with the semantic segmentation, meshing, and scene integration.

Clause 25. The pipeline in accordance with any preceding clauses, wherein the semantic segmentation is combined with a traditional Segment Anything Model to output fine-grained segmentations with class labels by exploiting a fine grained pipeline providing the fine grained segmentations with the semantic segmentation providing coarse grained segmentations and labels for the coarse grained segmentations applicable to the fine grained segmentations.

Clause 26. The pipeline in accordance with any preceding clauses, wherein the one or more processors are further configured to perform point cloud merging by leveraging segmentations per semantic class to limit overlap evaluation to be between a same semantic mask of frames.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” and “e.g.” are utilized herein to mean serving as an instance or illustration. Any aspect or design described herein as an “example” or referred to in connection with a “such as” clause or “e.g.” is not necessarily to be construed as preferred or advantageous over other aspects or designs described herein. Rather, use of the terms “example” or “such as” or “e.g.” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using special programming as described herein. In addition, various of the aspects disclosed herein also can be implemented by means of program modules or other types of computer program instructions specially configured as described herein and stored in a memory device and executed individually or in combination by one or more processors, or other combination of hardware and software, or hardware and firmware. Such specially configured program modules or computer program instructions, as described herein, can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any non-transitory computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A computer-implemented method, comprising:
deriving, by one or more processors from a pixel-wise semantic segmentation of at least two different image frames, object classifications representing one or more objects in the at least two different image frames;
deriving, by the one or more processors, geometric points representing the one or more objects in the at least two different image frames;
merging, by the one or more processors, the geometric points based on the object classifications that match and a mutually closest geometric point metric to obtain merged geometric points for each of the one or more objects; and
sending, by the one or more processors, instructions to control a movement of an autonomous object to achieve a task responsive to at least one of the one or more objects represented by the merged geometric points.

2. The computer-implemented method in accordance with claim 1, wherein the geometric points are merged in a process that is restricted to merging only objects in a same class.

3. The computer-implemented method in accordance with claim 2, wherein restricted to merging only objects in the same class skips any of the one or more objects that are in other classes from a particular merging of a given class.

4. The computer-implemented method in accordance with claim 1, wherein the geometric points are merged at a point cloud level.

5. The computer-implemented method in accordance with claim 4, wherein point cloud data for the at least one of the one or more objects in the at least different two image frames are mergeable only when the point cloud data for the at least one of the one or more objects in the at least different two image frames include an overlap by a threshold amount with respect to the mutually closest geometric point metric.

6. The computer-implemented method in accordance with claim 5, wherein the threshold amount is user adjustable.

7. The computer-implemented method in accordance with claim 5, further comprising determining the overlap using at least one respective mask for each the one or more objects in the at least two different image frames.

8. The computer-implemented method in accordance with claim 1, further comprising comparing pairs of the geometric points in different ones of the at least two different frames to identify pairs of mutually closest points in the at least two different frames for overlap evaluation.

9. The computer-implemented method in accordance with claim 1, further comprising performing the semantic segmentation using a closed set comprising segmentations and labels for the segmentations.

10. The computer-implemented method in accordance with claim 9, wherein the segmentations comprise X segmentations and the labels comprise Y labels, and wherein X and Y are integers greater than one and capable of being any of equal or different.

11. The computer-implemented method in accordance with claim 1, wherein the geometric points are merged further based on depth data.

12. The computer-implemented method in accordance with claim 1, wherein the geometric points are merged further based on camera pose data.

13. The computer-implemented method in accordance with claim 12, further comprising using the camera pose data to limit the geometric points that can be compared to each other for correspondence to have a same semantic label and to belong in a field-of-view of all camera poses under consideration.

14. The computer-implemented method in accordance with claim 1, wherein the geometric points are represented by image meshes and merged into scene meshes.

15. The computer-implemented method in accordance with claim 1, further comprising performing a voxel down-sampling operation by forming a grid over the geometric points, averaging all points with a same respective box of the grid to combine pixels in the same box of the grid into a resultant averaged pixel.

16. The computer-implemented method in accordance with claim 1, wherein controlling movement of the autonomous object comprises controlling movement of a robot to achieve the task responsive to the merged geometric points.

17. The computer-implemented method in accordance with claim 16, wherein the task comprises avoiding an obstacle.

18. The computer-implemented method in accordance with claim 16, wherein the task comprises moving an object from a first location to a second location.

19. A pipeline, comprising:
one or more processors operatively coupled to one or more memories and configured to derive, from a pixel-wise semantic segmentation of at least two different image frames, object classifications representing one or more objects in the at least two different image frames,
derive geometric points representing the one or more objects in the at least two different image frames,
merge the geometric points based on the object classifications that match and a mutually closest geometric point metric to obtain merged geometric points for each of the one or more objects, and
send instructions to control a movement of an autonomous object to achieve a task responsive to at least one of the one or more objects represented by the merged geometric points.

20. The pipeline in accordance with claim 19, wherein the one or more processors are further configured to implement a semantic segmentation branch and perform semantic segmentation on an image frame to output segmentations of the image frame and class labels for the segmentations from a closed set of segmentations and class labels, responsive to red, green, blue (RGB) image data.

21. The pipeline in accordance with claim 19, wherein the one or more processors are further configured to implement a mask branch configured to perform mask-based segmentation to output mask-based segmentations without class labels.

22. The pipeline in accordance with claim 21, wherein the one or more processors are further configured to perform semantic voting to output final segmentations with a finer granularity than the mask-based segmentation with final class labels, responsive to inputs comprising the segmentations and the labels for the segmentations output from the semantic segmentation and the mask-based segmentations output from the mask-based segmentation.

23. The pipeline in accordance with claim 19, wherein the one or more processors are further configued to generate three-dimensional (3D) scenes from perception that comprises color and depth information.

24. The pipeline in accordance with claim 19, wherein one or more processors are further configured to perform, along with the semantic segmentation, meshing, and scene integration.

25. The pipeline in accordance with claim 19, wherein the semantic segmentation is combined with a traditional Segment Anything Model to output fine-grained segmentations with class labels by exploiting a fine grained pipeline providing the fine grained segmentations with the semantic segmentation providing coarse grained segmentations and labels for the coarse grained segmentations applicable to the fine grained segmentations.

26. The pipeline in accordance with claim 19, wherein the one or more processors are further configured to perform point cloud merging by leveraging segmentations per semantic class to limit overlap evaluation to be between a same semantic mask of frames.
